(19) United States
(12) Patent Application Publication
(10) Pub. No.: US 2007/0160890 A1
(43) Pub. Date: Jul. 12, 2007

(54) Micro ejector static mixer for combining and homogenizing fluids

(76) Inventor: Bernhard A. Fischer, Rochester, NY (US)

Correspondence Address: DELPHI TECHNOLOGIES, INC., M/C 480-410-202, PO BOX 5052, TROY, MI, 48007, US

(21) Appl. No.: 11/327,869

(22) Filed: Jan. 9, 2006

(51) Int. Cl. H01M 8/04; H01M 8/06; B01F 5/06

(52) U.S. Cl. 429/34; 429/19; 366/340

(57) ABSTRACT

A static mixer including first, second, and third chambers arranged in flow sequence. Nozzles extend from the first chamber through the second chamber to matching orifices in a wall between the second and third chambers. A first fluid to be is forced through the nozzles, and a second fluid is entered into the second chamber. As the first fluid exits the nozzles, a Bernoulli aspiration effect is created at the nozzle outlet, entraining second fluid from the second chamber. The fluids are turbulently mixed, providing a homogeneous fluid mixture in the third chamber. Fluid pressure in the second chamber may be less than the pressure in either the first or third chambers. The mixer is especially useful in a solid oxide fuel cell system. A plurality of small individual Bernoulli aspirators may be packaged in a small mixer housing, providing excellent mixing with little pressure drop through the apparatus.

### TECHNICAL FIELD

The present invention relates to means for mixing dissimilar materials; more particularly, to mixers for homogenizing convergent streams of fluid materials; and most particularly, to a static mixing device employing a plurality of Bernoulli aspirators for joining and homogenizing streams of dissimilar fluids, which device is particularly useful in a reformer means for supplying reformate to a solid oxide fuel cell (SOFC) system.

### BACKGROUND OF THE INVENTION

Fuel cell system operations for highest system efficiencies require a high fuel cell stack fuel utilization (about 30% to 70%) and re-reforming of fuel cell anode exhaust gases, also known as anode tail gas or syngas. Because of combustion inefficiencies in a fuel cells, such exhaust gases still contain about 30% to 70% of the original fuel-bound energy in form of unreacted hydrogen (H₂) and carbon monoxide (CO).

It is known in the art to recirculate (“recycle”) a portion of the anode exhaust gas stream into the inlet to a reformer supplying reformed hydrocarbon fuel to an SOFC stack. The recirculated syngas is mixed with inlet air and unreacted (new) fuel ahead of the reformer. Because the inlet of the reformer and the fuel cell stack are arranged in flow sequence, pressure losses therethrough are additive, resulting in the static pressure at the anode outlet being several kilopascal below the pressure at the reformer inlet. Typically, a special high-temperature pump, or alternatively a syngas heat exchanger and low-temperature pump, is required to overcome the negative pressure gradient between the anode outlet and the reformer inlet in recycling a portion of the syngas into the reformer. Such a pump and/or heat exchanger adds undesirably to the cost and complexity of a fuel cell auxiliary power unit (APU) and in most cases requires an intercooler to mitigate the anode tail gas temperature (typically 750° C.) to a temperature acceptable to the recycle pump (typically below 200° C.). The loss in anode tail gas sensible energy has to be compensated by adding heat or molecular oxygen to the reactant stream to prevent unacceptable low temperature reformer operation. Adding sensible heat requires another heat exchange whereas adding oxygen will immediately reduce reforming efficiency.

Further, fluid mixing is of high level importance to the functionality, durability, and life of a fuel cell system. Due to low pressure loss requirements and the small overall size, the flows are laminar or at best harvest a small level of turbulence which cannot promote fast mixing down to a molecular level required for fuel reformer operation. The generation of a multitude of small scale laminar and low level turbulence mixers is imperative. In the prior art, it has proved difficult to provide homogeneous mixing of tail gas recycle, incoming air, and vaporized hydrocarbon fuel ahead of the reformer with a minimum of apparatus, mechanical volume, and capital expense.

What is needed in the art is a simple, inexpensive, static mixer for combining with minimal pressure drop a plurality of fluid streams, and especially gas streams, to provide a homogeneous fluid mixture.

What is further needed is a static means for helping to overcome a negative pressure gradient in a flow stream to be mixed.

It is a principal object of the present invention to provide a homogeneous fluid mixture.

It is a further object of the invention to improve the operating efficiency of a solid oxide fuel cell system while maintaining durability, life, and reliability.

### SUMMARY OF THE INVENTION

Briefly described, a static mixer in accordance with the invention includes first, second, and third chambers arranged in flow sequence. The first and second chambers share a common wall comprising a plurality of first orifices, each having a nozzle extending from the first chamber through the second chamber to the vicinity of a matching second orifice in a common wall between the second and third chambers.

In operation, a first fluid to be mixed with a second fluid is entered into the first chamber and is forced through the plurality of nozzles. The second fluid is entered into the second chamber. As the first fluid exits the nozzles and enters the second orifices in the form of first-fluid jets, a pressure drop is created according to the Bernoulli effect at the nozzle outlet, entraining second fluid from the second chamber into the first-fluid flow stream. First and second fluids are immediately and turbulently mixed, providing a homogeneous fluid mixture in the third chamber. The plurality of small scale mixers provides homogeneous mixtures at low levels of turbulence and even in laminar flow conditions. Because the second fluid is eductively drawn into the first-fluid stream, fluid pressure in the second chamber may be significantly less than the pressure in either the first or third chambers.

A static mixer in accordance with the invention is especially useful in mixing gases, and especially in a solid oxide fuel cell system. For example, the first fluid may be air, vaporized fuel, recycled gas, or a combination thereof, and the second fluid may be air, vaporized fuel, recycled anode tail gas, or a combination thereof or any gas or mixture of gases. The nozzle sizes, spacings, wall thicknesses, fluid pressures, and orifice diameters may be varied in accordance with known principles to provide desired flow rates of first and second fluids. An especial advantage of the invention is that a plurality of very small individual Bernoulli aspirators may be packaged in a relatively small mixer housing, providing excellent mixing with relatively little pressure drop through the mixer which can be easily sized for any power level required by simple adjustment of the number of individual mixers. Mixture quality across the face of the mixture can be optimized by adjusting the sizes of individual tubes or secondary holes.

### BRIEF DESCRIPTION OF THE DRAWINGS

The present invention will now be described, by way of example, with reference to the accompanying drawings, in which:

FIG. 1 is a cutaway view from the front of a portion of a first embodiment of a static mixer in accordance with the invention;

FIG. 2 is an elevational cross-sectional view of the static mixer shown in FIG. 1;

FIG. 3 is an enlarged and detailed view taken in circle 3 in FIG. 2;

FIG. 4 is an isometric view of a portion of a second embodiment of a static mixer in accordance with the invention; and

FIG. 5 is a schematic cross-sectional view of the mixer embodiment shown in FIG. 4, showing primary fluid flow, aspiration of a secondary fluid, and homogenization of the fluids by turbulence downstream of the Bernoulli regions.

### DESCRIPTION OF THE PREFERRED EMBODIMENTS

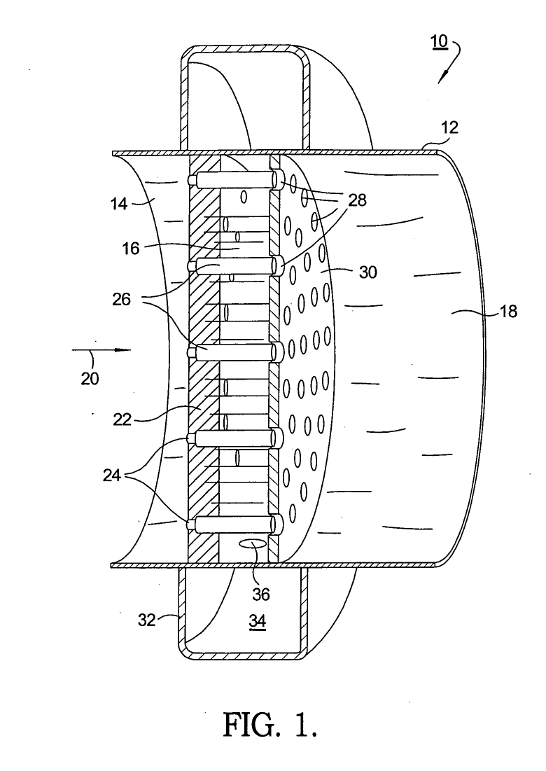

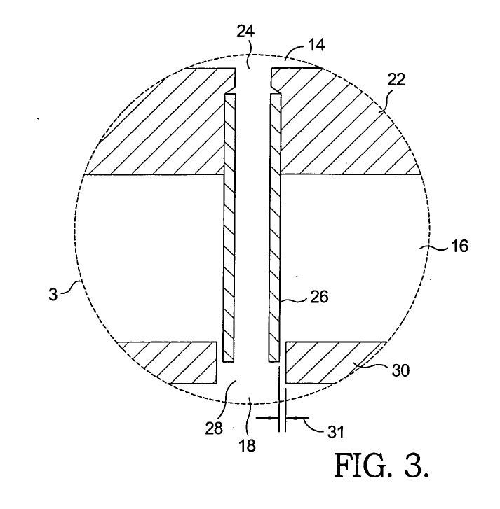

Referring to FIGS. 1 through 3, a first embodiment 10 of a fluid static mixer in accordance with the invention includes a housing 12 having first, second, and third chambers 14, 16, 18 arranged in flow sequence of a first fluid 20. First and second chambers 14, 16 share a common wall 22 comprising a plurality of first orifices 24, each such orifice having a nozzle 26 forming a flow passage extending from first chamber 14 through second chamber 16 and proximate a matching second orifice 28 in a common wall 30 between second and third chambers 16, 18. An annular space 31 is provided between the outer wall of each nozzle 26 and the wall of each second orifice 28. A manifold 32 surrounds second chamber 16 for supplying a second fluid 34 into second chamber 16 via radial ports 36.

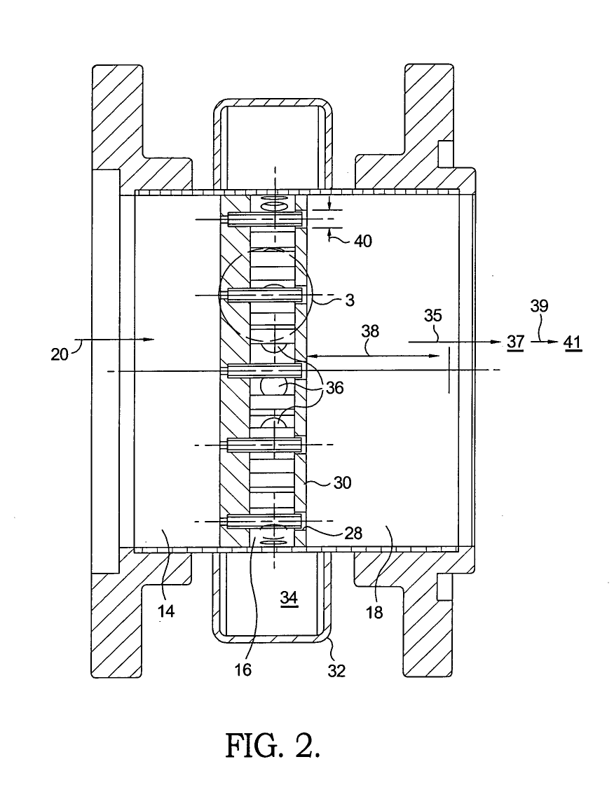

In operation, first fluid 20 to be mixed with second fluid 34 is entered into the first chamber 14 and is forced through the plurality of orifices 24 and nozzles 26. Second fluid 34 is entered into second chamber 16 from manifold 32 via ports 36. The ports 36 are arranged in such a way that the pressure loss in the annulus is compensated to allow for equal mass flows across each port (similar to a volute design). This is important in guaranteeing equal flows through annular ports 28. As first fluid 20 exits nozzles 26 in second orifices 28 in the form of first-fluid jets, a pressure drop is created in second orifices 28, entraining second fluid 34 from second chamber 16 into the first-fluid flow stream. Alternatively, the pressure can be supplied by a pump upstream of the annular chamber 32. First and second fluids 20, 34 pass out of second orifices 28 and are immediately mixed by turbulence and molecular diffusion processes as they expand into third chamber 18 providing a homogeneous fluid mixture 35 in the third chamber. As shown in FIG. 2, such mixing occurs within a distance 38 from second wall 30 equal to or less than about ten to fifteen diameters 40 of second orifices 28. Homogeneous mixture 35 may be directed to, for example, a hydrocarbon reformer 37 for providing reformate 39 to a solid oxide fuel cell stack 41, the combination of mixer 10, reformer 37, and stack 41 defining a solid oxide fuel cell system.

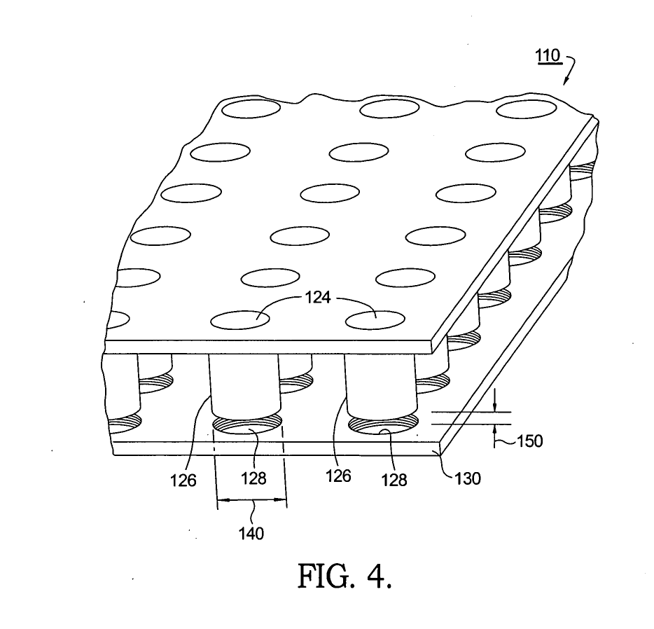

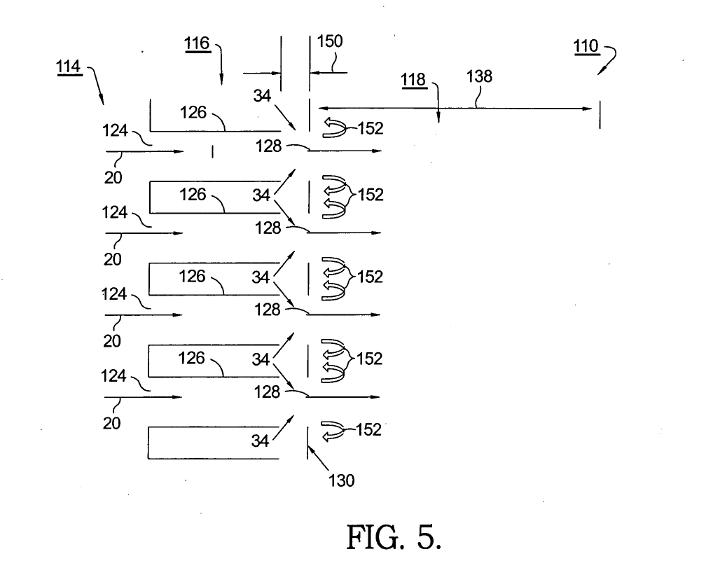

Referring to FIGS. 4 and 5, a second embodiment 110 of a fluid static mixer in accordance with the invention is similar to first embodiment 10 in all respects except that nozzles 126 do not extend into second orifices 128 but rather terminate in ends off-spaced (ends at wall or before) from second wall 130 by a distance 150. As in embodiment 10, the jet of first fluid 20 from first chamber 114 entering first orifices 24 and exiting nozzles 126 creates a Bernoulli effect, entraining second fluid 34 from second chamber 116 and causing mixing by turbulence 152 in third chamber 118 at a distance 138 from second wall 130. Preferable, distance 138 is equal to or less than about 10 diameters 140 of second orifices 128.

A static ejector mixer employing Bernoulli aspiration in accordance with the invention is useful for mixing all or any combination of fluids including liquid or gaseous fuel, air, steam, and SOFC anode tail gas recycle. In an SOFC application, the present static mixer can assist the duty of a recycle pump or in some applications may render a recycle pump unnecessary altogether.

The present invention allows for modular design and therefore is not dependent upon size, shape, or load, therefore permitting inexpensive mass production and design flexibility for optimize use in any given application.

In a currently preferred embodiment, first orifices 24, 124 are between about 0.1 mm and about 5 mm in diameter. Both the number and size of the orifices are selected to accommodate a pressure drop through nozzles 26, 126 enabling acceleration in flow velocity of first fluid 20. Preferably, the planar arrangement of first and second orifices 24, 124, 28, 128 is not square or rectangular but may otherwise assume any shape desired. Further, the orifices preferably are not all of a given diameter but rather are varied to compensate for variations in pressure loss within the mixer.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A static mixer for mixing flowing streams of first and second fluids, comprising:
a) a housing containing a first chamber for receiving said first fluid, a second chamber for receiving said second fluid, and a third chamber for receiving conjoined streams of said first and second fluids, said first and second chambers being separated by a first wall perforated by a plurality of first orifices, said second and third chambers being separated by a second wall perforated by a plurality of second orifices; and
b) a plurality of nozzles extending from said first orifices through said second chamber and terminating in the vicinity of said second orifices,
wherein first fluid flowing from said first chamber through said nozzles and exiting said nozzles entrains and mixes with second fluid from said second chamber in accordance with a Bernoulli effect, the admixture flowing through said second orifices into said third chamber wherein the admixture is homogenized by turbulence.

2. A static mixer in accordance with claim 1 wherein the diameters of said first orifices are between about 0.1 mm and about 5 mm.

3. A static mixer in accordance with claim 1 wherein various of said first orifices and nozzles have differing diameters.

4. A static mixer in accordance with claim 1 wherein one of said first and second fluids is anode tail gas from a solid oxide fuel cell stack.

5. A static mixer in accordance with claim 4 wherein said anode tail gas is said second fluid.

6. A static mixer in accordance with claim 1 further comprising at least one manifold for entering at least one of said first and second fluids into said housing.

7. A static mixer in accordance with claim 1 wherein said first and second fluids are selected from the group consisting of liquid or gaseous fuel, air, steam, and SOFC anode tail gas.

8. A static mixer in accordance with claim 1 wherein said nozzles extend into said second orifices, creating an annular space therebetween.

9. A static mixer in accordance with claim 1 wherein said nozzles terminate in said second chamber adjacent said second orifices.

10. A solid oxide fuel cell system comprising:
a) a fuel cell stack for producing electricity and anode tail gas;
b) a reformate source for providing reformate as fuel for said stack; and
c) a static mixer for mixing a portion of said anode tail gas with at least one of hydrocarbon fuel and air ahead of said reformer to provide a fuel mixture for said reformer, said static mixer including
a housing containing a first chamber for receiving said fuel/air mixture, a second chamber for receiving said anode tail gas, and a third chamber for receiving conjoined streams of said at least one of said hydrocarbon fuel and air and said anode tail gas, said first and second chambers being separated by a first wall perforated by a plurality of first orifices, said second and third chambers being separated by a second wall perforated by a plurality of second orifices, and
a plurality of nozzles extending from said first orifices through said second chamber and terminating in the vicinity of said second orifices,
wherein said at least one of said hydrocarbon fuel and air flowing from said first chamber through said nozzles and exiting said nozzles entrains and mixes with anode tail gas from said second chamber in accordance with a Bernoulli effect, the admixture flowing through said second orifices into said third chamber wherein the admixture is homogenized by turbulence and provided to said reformer.
